(19) United States
(12) Patent Application Publication
(10) Pub. No.: US 2014/0217663 A1
(43) Pub. Date: Aug. 7, 2014

(54) ROTARY DAMPER

(71) Applicant: Marco Willems, Ingolstadt (DE)

(72) Inventor: Marco Willems, Ingolstadt (DE)

(73) Assignee: Audi AG, Ingolstadt (DE)

(21) Appl. No.: 14/116,592

(22) PCT Filed: May 8, 2012
(86) PCT No.: PCT/EP2012/001962

§ 371 Date: Mar. 3, 2014

(30) Foreign Application Priority Data
May 12, 2011 (DE) 10 2011 101 350.8

(51) Int. Cl. B60G 15/02; B60G 15/06

(52) U.S. Cl. CPC B60G 15/02; B60G 15/06
USPC 267/196; 267/195; 267/217; 267/219

(57) ABSTRACT

Rotary damper (1) for a motor vehicle, with at least one damping element (2) for damping the relative movement between a first mass disposed on the wheel suspension side and a second mass disposed on the vehicle body side. The damping element (2) has at least one rotatable damper part, which can be set in rotation by a lever element (5) that moves as a result of the motion of the mass and is mechanically coupled to the damping element to permit motion, wherein at least one spring damping element (6) is integrated into the mechanical motion-coupling between the lever element (5) and the rotatable damper part.

The invention relates to a rotary damper for a motor vehicle, with at least one damping element for damping the relative movement between a first mass arranged on the side of a wheel suspension and a second mass arranged on the side of the vehicle body.

It is required in many technical fields to dampen relative movements between two components of a vibratory mechanical system. An example is the vibration damping on a motor vehicle body in the region where the body is mounted on the suspension. For example, linear hydraulic dampers are used for this purpose. In corresponding linear dampers, the connecting points on the vehicle body and the suspension, respectively, disposed in the direction of force are provided with elastomer bearings, thereby attaining vibration isolation and thus a reduction of vibrations generated during the operation of the motor vehicle, for example when a vehicle wheel rolls on the ground.

Rotary dampers represent an alternative to the aforementioned telescopic dampers and are well known. The operation of a rotary damper is based in principle on a lever element arranged on the side of the wheel suspension, which is movable in a relative mass movement and which is directly or indirectly motion-coupled with a rotatably supported damper part of the damping element associated with the rotary damper, whereby a rotary motion is imparted on the corresponding damping element.

Vibration decoupling via corresponding elastomer bearings, such as with linear dampers mentioned above, is not possible with rotary dampers, since the force is converted here from a linear force into a force extending perpendicular thereto or to a torque, respectively. The absorption behavior of conventional rotary dampers with respect to vibrations produced during the operation of the vehicle is thus reduced, in particular compared to linear dampers.

The invention thus addresses the problem of providing a rotary damper having an improved absorption capacity for vibrations produced during the operation of the motor vehicle.

The problem is solved with a rotary damper of the aforementioned type, which is characterized in that the damping element has at least a rotatable damper part on which a rotary motion can be imparted via a lever element that is mechanically motion-coupled to the rotatable damper part and which can be set in a rotary motion by the mass movement, wherein at least one spring damping element is integrated in mechanical motion coupling between the lever element and rotatable damper part.

The present invention is based on the concept of introducing at least one spring damping element in the mechanical motion coupling, so as to realize at least one decoupling stage between the vehicle body and the wheel suspension. Vibrations generated during operation of the motor vehicle and/or of the rotary damper are then reduced or attenuated, thereby reducing in particular acoustically perceptible vibrations that diminish the driving comfort.

The at least one spring damping element is thus a direct component of the rotary damper, whereby corresponding vibrations can be damped before propagating into the passenger compartment where they are frequently seen as annoying. The spring damping element, which can be regarded as an vibration-decoupling interface between the lever element and the rotatable damper part connected in series between the lever element and the rotatable damper part, enables transmission of a force or torque to be transmitted from the lever element to the rotary damping element.

By integrating the spring damping element into the mechanical motion coupling between the lever element and the rotatable damper part associated with the damping element, the principle of the invention is also compact and takes into account the limited space within a wheel housing receiving the respective rotary damper.

The spring damping element employed according to the invention may be used in other embodiments to be described hereinafter in more detail and may be adjusted to a corresponding frequency spectrum of vibrations individually as needed, so that in particular high-frequency or low-frequency vibrations can be specifically attenuated. In particular, acoustically perceptible high-frequency vibrations with a small amplitude can be damped. By way of example only, vibrations in the range of 1 kHz-30 kHz can be attenuated with a suitably designed spring damping element.

According to one embodiment of the invention, the spring damping element may be arranged at least partially in a receiving space extending between the lever element and the rotary damper part or in a receiving space extending between the lever element and a component connected in a rotationally fixed manner to the rotary damper part. The shape and dimensions of the spring damping element are usually matched to the shape and dimensions of the receiving space, thus resulting in a stable, preferably captive arrangement of the spring damping element within the receiving space.

The receiving space and optionally also the spring damping element may have an annular shape or the shape of a ring segment. Accordingly, the spring damping element has then preferably also an annular shape, allowing the spring damping element to completely fill the receiving space upon insertion. Likewise, the spring damping element may also be formed only as a corresponding ring segment, so that the spring damping element only partially circumferentially fills the receiving space after insertion. At least one additional ring segment-shaped spring damping element can be inserted into the areas of the annular receiving space that are not filled. In other words, the spring damping element can also be circumferentially designed in several parts and have a corresponding number of spring damping element sections. Embodiments of the spring damping element in form of a plurality of circumferentially distributed radial webs that extend radially through the annular receiving space as individual spring damping element sections are also feasible. The same applies of course also to a receiving space shaped only as ring segments.

Besides the described respectively annular ring segment-shaped design of the receiving space, other geometric embodiments of the receiving space, and consequently of the spring damping element or the corresponding spring damping element sections are also feasible. These include, for example, rectangular or polygonal receiving spaces, i.e. six-or eight sided receiving spaces.

The arrangement of the spring damping element within a corresponding receiving space can be accomplished, for example, by a press fit or by a clamping fit of the spring damping element on the rotatable damper part or the component connected to the rotatable damper part in a non-rotatable fashion. Furthermore, depending on the choice of materials used for the lever element, the spring damping element, the rotatable damper part or optionally the component connected to the rotary damper part in a non-rotatable fashion, adhesive, welded or soldered joints can be used for arranging the spring damping element in a corresponding receiving space. Radially protruding non-positively and/or positively interlocking elements may also be arranged on the spring-damping element-side or on the lever element-side, which engage in correspondingly shaped, mating receiving sections disposed on the lever-element-side or the spring-damping-element-side. The same applies to a corresponding connection between the spring damping element and a component connected in a non-rotatable fashion to the rotatable damper part.

The spring damping element may also include at least two spring damping element sections which are mechanically motion-coupled via a connecting element. In this embodiment, at least one connecting element, on which the spring damping element portions are arranged, may be integrated in the mechanical motion-coupling between the lever element and the rotatable damper part, wherein for example at least one spring damping element section is in contact with the lever element and at least one other spring damping element section is in contact with the rotatable damper part. The connecting element is optionally formed as a concentric ring and connected to the spring damping element sections and arranged between the respective spring damping element sections. Accordingly, the rotational movements motion of the radially outer spring damping element section(s) are transmitted by way of the connecting element to the radially inner spring damping element section(s) and further to the rotatable damper part. By constructing the spring damping element as multiple elements in form of a plurality of corresponding radially spaced spring damping element sections separated by at least one connecting element therebetween, multi-stage decoupling can be attained, thereby further increasing the absorption capacity of the rotary damper for corresponding vibrations.

The spring damping element is advantageously formed from an elastomer material. The term “elastomer material” refers to both natural and synthetically produced elastomers. Rubber materials based on polybutadiene are only mentioned by way of example, wherein their absorption characteristic for corresponding vibrations can be adjusted by varying the degree of vulcanization or cross-linking. Suitable thermoplastic elastomers (TPE) processable in an injection molding process can also be used to form the spring damping element.

To further adjust the absorption characteristic of the spring damping element of the invention, at least one metallic carrier may be integrated in the elastomer material, in particular enclosed or overmolded. Consequently, a specific absorption spectrum can then be generated to a large extent by the viscous material properties produced by the elastomer material and the elastic material properties largely produced by the metallic carrier. Additionally or alternatively, a component generating frictional damping may be incorporated as a component of the spring damping element, so that its damping effect is fundamentally based on the principle of spring damping and/or viscosity damping and/or friction damping.

Furthermore, a gear may be arranged between the lever element and the damping element, wherein at least one first gear element is motion-coupled to the lever element and set in a rotary motion by the first gear element, and at least one second gear element which is directly or indirectly geared to the first gear element is motion-coupled to the second damper part, such that the second damper part performs a rotational motion. The interposition of a gear allows the movement of the lever element to be stepped up, so that comparatively small movements or deflections of the lever element cause a large number of revolutions or a high rotational speed of the second damper part of the damping element. The damping effect of the damping element can thus be increased commensurately.

The gear can be designed, for example, as a planetary gear, a strain wave gear, a cycloid gear or a spur gear. Other gear types are also conceivable.

The rotary damper may be configured as a hydraulic rotary damper with at least one hydraulic damping element or as an electric rotary damper with at least one electric damping element. In the former case, the damping effect of the damping element is based on the circulation of a fluid received in a volume associated with the damping element, e.g. a suitable hydraulic oil or the like. In the latter case, the damping element can convert mechanical energy into electrical energy. In this embodiment, the rotary damper includes a generator driven by the movement of a mass with a fixed stator and a rotor rotatable relative thereto, as well as advantageously a gear coupled to the generator. The principle of operation of the electric damper is based on the coupling of the generator to the gear, wherein the output element of the gear transmits to the rotor a rotational motion introduced directly via the lever element coupled to a drive element of the gear. The rotational motion introduced into the rotor causes the damping via the generator and the recovery or conversion of the mechanical damping energy originating from the movement of the mass into electric current on the generator side.

Additional advantages, features and details of the invention will become apparent from the exemplary embodiments described hereinafter and with reference to the drawings, which show in:

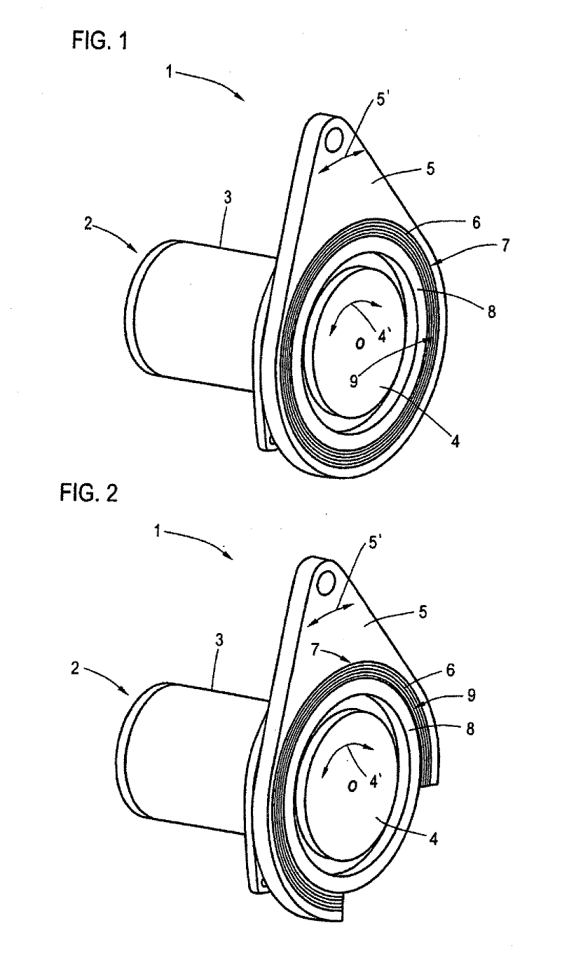

FIG. 1 a schematic diagram of a rotary damper according to a first exemplary embodiment;

FIG. 2 a schematic diagram of a rotary damper according to a second exemplary embodiment;

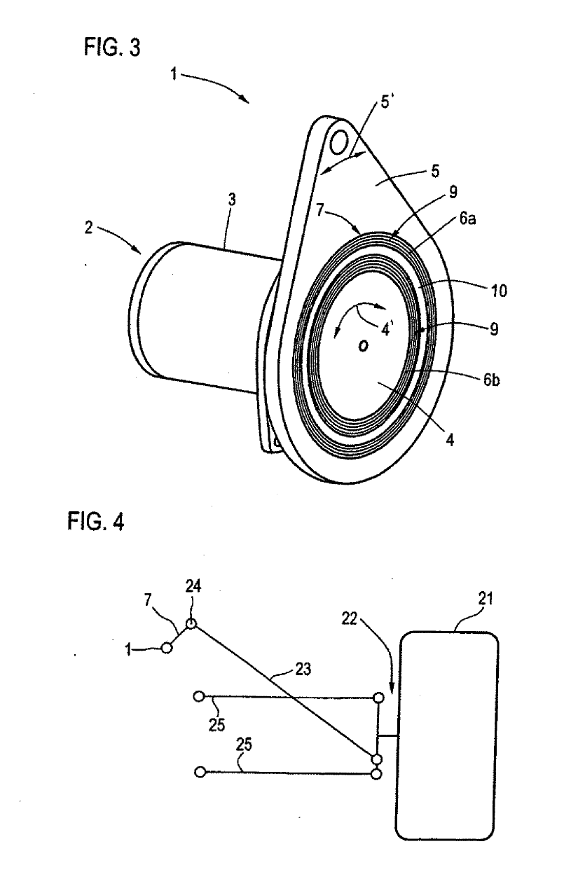

FIG. 3 a schematic diagram of a rotary damper according to a third exemplary embodiment, and

FIG. 4 a schematic diagram of a possible installation situation of a rotary damper in the area of a motor vehicle axle.

FIG. 1 shows a schematic diagram of a rotary damper 1 according to a first exemplary embodiment. The rotary damper 1 is installed in a wheel well of a motor vehicle (not shown) and includes a damping element 2 for damping the relative movement between a first mass disposed on the wheel-suspension-side and a second mass disposed on the vehicle-body-side. The damping element 2 may be designed, for example, as an electrical damper.

The damping element 2 has within the hollow cylindrical housing 3 a fixed first damper part (not shown) and a second damper part (not shown) mounted rotatably relative thereto to generate a damping force. The second damper part is connected via a reversing bearing 4 to a lever element 5 (control lever) that can be moved or pivoted by the mass motion (see the double arrow 5′) and connected to the first mass. The lever element 5 transmits a rotary motion or a torque (see double arrow 4′) during a mass motion to the reversing bearing 4 and to the second damper part that is motion-coupled thereto. This can produce acoustically perceptible vibrations which are typically perceived as unpleasant by the passenger entering the passenger compartment.

To reduce, respectively attenuate corresponding vibrations, a spring damping element 6 is integrated in the mechanical motion coupling between the lever element 5 and the reversing bearing 4 or the rotatable damper part, i.e. in the transmission path from the lever element 5 and reversing bearing 4. The spring damping element 6 is hence used for vibration isolation between the wheel suspension and the vehicle body.

The spring damping element 6 is ring-shaped and is arranged in a likewise annular receiving space 9 extending between an annular groove 7 of the lever element 5 and the outer circumference of a component 8 that is connected in a rotationally fixed manner to the reversing bearing 4 and thus indirectly to the rotatable damper part. A stable arrangement of the spring damping element 6 within the receiving space 9 is ensured, for example, by an adhesive joint.

The spring damping element 6 is formed as a closed elastomer ring from an elastomer material, for example, from synthetic rubber such as styrene-butadiene rubber (SBR). As indicated, the spring damping element 6 may have a grooved surface structure. In addition, a metallic support may be incorporated in the elastomer material, which affects the absorption spectrum of the spring damping element 6, so that the spring damping element 6 may be designed to intentionally attenuate specific frequencies. Similarly, the spring damping element 6 may also be divided into a plurality of spring damping element sections arranged in the receiving space 9, thereby creating inside the receiving space 9 ring-segment-shaped or ring-shaped spring damping element sections which are circumferentially distributed or arranged in individual layers one above another and which completely or partly fill the receiving space 9. In principle, damping of the spring based damping element 6 is based on the principle of spring damping and/or viscous damping and/or friction damping.

It would also be conceivable to arrange the spring damping element 6 directly on the outer periphery of the reversing bearing 4, thus theoretically obviating the need for the component 8 that is connected in a rotationally fixed manner with the reversing bearing 4.

FIG. 2 shows a schematic diagram of a rotary damper 1 according to a second exemplary embodiment. The main difference to the embodiment shown in FIG. 1 lies in the shape of the lever element 5 and of the recess 7 associated therewith and receiving the spring damping element 8, respectively, which is here formed only as a ring segment, so that the lever element 5 as a whole has a claw shape. Preferably, the ring-segment-shaped recess 7 extends over an angle of more than 180°, so that the likewise, but not necessarily, ring-segment-shaped element 8 and the reversing bearing 4 are both held in the recess 7 by a form fit.

FIG. 3 shows a schematic diagram of a rotary damper 1 according to a third exemplary embodiment, which illustrates a possible multi-stage vibration decoupling between the wheel suspension and the vehicle body, wherein the spring damping element 6 has two spring damping element sections 6a, 6b, which are mechanically motion-coupled via an annular connecting element 10. The spring damping element section 6a that assumes a radially outer position substantially corresponds to the spring damping element 6 shown in FIG. 1. The spring damping element section 6b that in comparison assumes a radially inner position is in this embodiment disposed directly on the outer periphery of reversing bearing 4. However, it will be understood that a component 8 that is connected in a non-rotatable fashion to the reversing bearing 4 may also be provided, wherein the spring damping element section 6b is motion-coupled to the outer periphery of the component 8. The principle shown in FIG. 3 can of course also be applied to a spring damping element 6 having more than two-spring damping element sections 6a, 6b, 6i, in which case a commensurate number of connecting parts 10 would, of course, have to be provided.

Although not shown in the embodiments illustrated in the FIGS. 1 to 3, a gear may be arranged between the lever element 5 and the damping element 2. In this case, at least one first gear element is motion-coupled to the lever element 5 and can be rotated by the lever element 5. A second gear element which is directly or indirectly coupled with a gear ratio to the first gear element would then be motion-coupled to the reversing bearing 4 or to the damper part connected thereto in a non-rotatable fashion, thus causing the rotatable damper part to rotate.

The gear may be formed, for example, as a planetary gear, a strain wave gear, a cycloid gear or a spur gear.

Lastly, FIG. 4 shows a schematic diagram of a possible installation of a rotary damper 1 in the area of a motor vehicle axle. Shown as part of a motor vehicle is a vehicle wheel 11 together with a wheel carrier 12, on which a push rod 13 that is connected to the lever element 5 is arranged. The lever element 5 is pivotally supported for pivoting about the rotation axis 14, wherein the rotary damper 1 of the invention is disposed in the rotation axis 14.

Alternatively, the rotary damper 1 may be integrated directly into the rotary suspension of at least one transverse control arm 15. When the vehicle wheel 11 moves up and down, the lever element 5 is moved by the push rod 13 and pivoted about the rotation axis 14, which operates the rotary damper 1 of the invention.

1-11. (canceled)

12. A rotary damper for a motor vehicle, comprising:
at least one hydraulic or electric damping element for damping the relative movement between a first mass arranged on a wheel-suspension-side of the motor vehicle and a second mass arranged on the vehicle-body-side of the motor vehicle, wherein the at least one damping element comprises at least one stationary damper part and at least one rotatable damper part, which is supported for rotation about the at least one stationary damper part and generates a damping force,
a lever element that is mechanically motion-coupled to the rotatable damper part and moved by movement of the first and second masses imparting a rotational movement on the at least one rotatable damper part, and
at least one spring damping element integrated between the lever element and the at least one rotatable damper part to provide mechanical motion-coupling between the lever element and the stationary damper part.

13. The rotary damper of claim 12, wherein the at least one spring damping element is at least partially arranged in a receiving space extending between the lever element and the rotatable damper part, or in a receiving space extending between the lever element and a component connected to the rotary damper part in a rotationally fixed manner.

14. The rotary damper of claim 13, wherein the receiving space has an annular shape or a ring-segment shape.

15. The rotary damper of claim 13, wherein the at least one spring damping element has an annular shape or a ring-segment shape.

16. The rotary damper of claim 12, wherein the at least one spring damping element comprises at least two damping sections, and a connecting element mechanically motion-coupling the at least two damping sections.

17. The rotary damper of claim 13, wherein the at least one spring damping element is installed in the receiving space by a press-fit, by clamping or by gluing.

18. The rotary damper of claim 12, wherein the at least one spring damping element generates a damping effect based on at least one of spring damping, viscous damping and friction damping.

19. The rotary damper of claim 12, wherein the at least one spring damping element is formed from an elastomer material.

20. The rotary damper of claim 19, further comprising at least one metallic carrier integrated in the elastomer material.

21. The rotary damper of claim 20, wherein the at least one metallic carrier is enclosed by the elastomer material.

22. The rotary damper of claim 12, further comprising a gear arranged between the lever element and the at least one hydraulic or electric damping element, wherein at least one first gear element is motion-coupled with the lever element and can be set in rotation by the lever element, and at least one second gear element that is either directly or indirectly coupled by a gear ratio to the first gear element is motion-coupled to the rotatable damper part so as to cause a rotary motion of the rotatable damper part.

23. The rotary damper of claim 22, wherein the gear is constructed as a planetary gear, a strain wave gear, a cycloid gear or a spur gear.

24. The rotary damper of claim 12, comprising at least one hydraulic damping element when constructed as a hydraulic damper, or comprising at least one electrical damping element when constructed as an electric rotary damper.
